(19) United States
(12) Patent Application Publication
(10) Pub. No.: US 2002/0092607 A1
(43) Pub. Date: Jul. 18, 2002

(54) Label with adhesive on two sides

(76) Inventors: Steven Lee Hassenzahl, Liburn, GA (US); David Glenn Tarlton, Atlanta, GA (US); Shane Dion Laney, Lawrenceville, GA (US); Jason Alan Mastry, Duluth, GA (US)

Correspondence Address: Motorola Energy Systems Group, Intellectual Property Department, 1700 Belle Meade Court, Lawrenceville, GA, 30043, US

(21) Appl. No.: 09/761,345

(22) Filed: Jan. 17, 2001

(51) Int. Cl. B32B 31/00

(52) U.S. Cl. 156/247; 283/81

(57) ABSTRACT

This invention includes a label having a front and rear face. The label can be used to attach devices together. For example, the label can be used to attach rechargeable cells into electronic devices where height tolerances are small. The front face of the label includes a first portion that can be printed upon, and a second portion coated with pressure sensitive adhesive. The rear face is coated entirely with pressure sensitive adhesive. In one embodiment, battery information can be printed on the first portion of the front face. The rear face attaches to the cell, while the second portion attaches to an electronic device. The invention allows embedded cells to be integrated into electronic devices without the need for snaps, screws, latches, and the like.

### TECHNICAL FIELD

This invention relates generally to labels with adhesive, and more specifically to a label having pressure sensitive adhesive on more than one side.

### BACKGROUND

Portable electronics are becoming smaller and smaller. For example, the PalmPilot™ personal data assistant (PDA) manufactured by Palm, Inc. started with a thickness of nearly an inch. Several generations later, the Palm V™ PDA is less than half that thickness. Cellular phones have also gotten smaller. While the MicroTac™ manufactured by Motorola was nearly 6″×3″, the V-Series™ phone is about a quarter of that size.

This reduction in size has demanded that all internal components become smaller as well. While batteries for portable devices like phones used to be large, bulky devices carried around in a bag, they are now small, advanced chemistry devices. The typical lithium-ion cell found in a Palm V PDA or V-series phone, for example, measures only 2″×1.5″.

While the battery itself has gotten smaller, the accessories about it have not been reduced in proportionate size. Typically batteries are secured in the electronic device with a housing that either snaps or screws in place. Screws require mating holes and bosses and must be capable of being tightened by a screwdriver. Snaps must be capable of actuation by either fingers or tools. As a result, many designers are finding that it is the battery and surrounding hardware that limits the total amount of size reduction for any portable electronic device.

Consequently, there is a need for an improved method of attaching a battery in an electronic device that allows the overall size of the device to be reduced.

### BRIEF DESCRIPTION OF THE DRAWINGS

FIG. 1 illustrates prior art.

FIG. 2 illustrates a first face of a label in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

As discussed above, with the miniaturization of semiconductors, electronic devices are constantly getting thinner. In the past, most electronic devices, including portable radios, pagers and the like, have had detachable batteries. These may be primary, or single use batteries like alkaline, or they may be rechargeable batteries like Nickel-Metal Hydride and Lithium-Ion. Such batteries are manufactured in a rugged housing and generally snap, latch or screw into the host device.

As electronics become more sophisticated, consumers are demanding that the batteries be of the rechargeable type only, as they are tired of constantly buying and throwing away primary batteries. As electronics become smaller, there is no longer room for a rugged outer housing about the battery cell. Consequently, many electronics manufacturers are equipping their products with “embedded cells” that cannot be removed from the device. In other words, the battery is permanently affixed within the device. One charges the battery by connecting the entire electronic device to a charger. In this manner, the electronic device housing serves as both protection for the device and as a rugged housing for the cell.

The problem arises, however, as to just how to connect the cell to the electronic device. When cells were removable, the rugged housing would often have a latch or snap feature that mated with the housing of the electronic device. Raw cells by themselves are typically smooth, soft metal cans. Designers had to come up with novel ways of connecting the cell to the housing so that the cell would not be damaged with the electronic device was shaken or dropped.

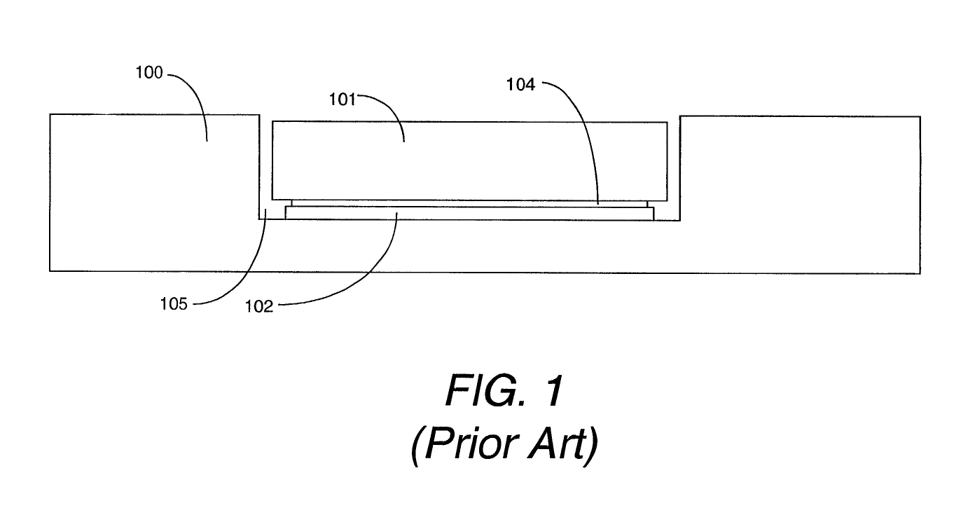

Referring now to FIG. 1, illustrated therein is one prior art solution. An electronic device 100 is shown with a battery 101 in the battery pocket 105. The battery 101 has a label 104 that identifies the chemistry, capacity and safety precautions. Such identifying marks are required by governmental regulatory agencies, the Underwriter's Laboratories, and by many manufacturers as well. The designer has attached a piece of polyvinyl, double-sided pressure sensitive adhesive (PSA) 102 that causes the battery 101 to “stick” to the electronic device. A high strength, permanent adhesive is required to last for the life of the electronic device. TesaFix™ brand adhesive material is suitable for such purposes.

While this solution works, electronic manufacturers today desire to build even thinner electronic devices. Such devices would not accommodate the stack height of the battery, the PSA and the label. The present invention allows electronic manufacturers to build electronics without this three-layer stack height.

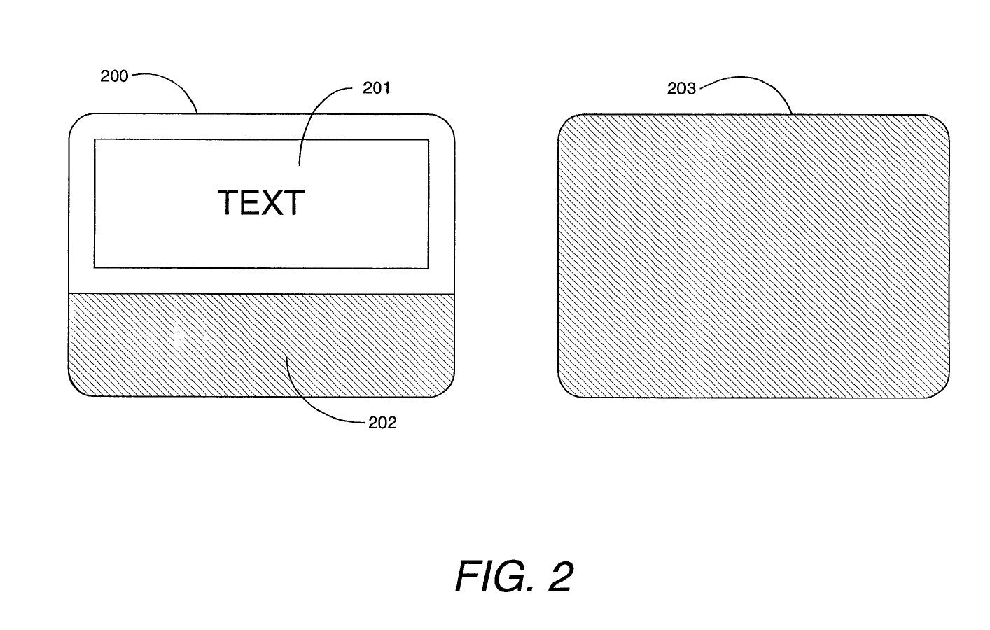

Referring now to FIG. 2, illustrated therein is a preferred embodiment of the invention. The invention comprises a label having a front face 200 and a rear face 203. The front face has two portions. The first portion 201 is smooth and suitable for printing. The second portion 202 is coated with a pressure sensitive adhesive. After coating with pressure sensitive adhesive, the second portion is covered with a removable, glossy overlaminate (not shown) to prevent the pressure sensitive adhesive on the second portion 202 from sticking to anything until the overlaminate is removed.

The back face 203 is completely covered with pressure sensitive adhesive. Ideally, the labels are manufactured on a reel having a backing that is glossy, thereby allowing back face 203 to contact the backing. Alternatively, the back face 203 could have a second overlaminate to prevent the back face 203 from sticking to anything until the second overlaminate was removed.

In either case, the first portion 201 of the front face 200 can be printed with information in a manner known in the art. In the case of rechargeable cells, this may include manufacturer data, safety precautions, capacity and charging data, and so on. Once the label has been printed, the cell manufacturer removes the label from the reel, thereby exposing the back face 203 and its pressure sensitive adhesive. The back face 203 is then pressed on a rechargeable cell, so that the label is readable. The cell can then be shipped to the electronics manufacturer.

When the manufacturer receives the cell, it is easily identified by reading the label. The electronics manufacturer is thus able to sort the cells for deployment into the manufacturing process. When the cell is to be assembled into the product, the assembler simply removes the overlaminate on the front face 200, thereby exposing the pressure sensitive adhesive on the second portion 202. The assembler can then insert the cell into the device, label side down, such that the pressure sensitive adhesive on the second portion 202 of the front face 200 comes into contact with the electronic device. By gently depressing the cell, the pressure sensitive adhesive forms a bond between the electronic device and the cell. The cell is thus secure.

By way of example, such a label was reduced to practice in the lab and found to be quite effective. The label was for a single-cell lithium-ion battery. The label measured 44×25 mm. The rear face was completely covered in pressure sensitive adhesive. The second portion on the front face was coated with pressure sensitive adhesive and measures 10×44 mm. The label was manufactured of polyester film with an overall thickness of 0.13 mm.

The pressure sensitive adhesive used was an acrylic based adhesive, model number 945B, manufactured by 3M. This particular adhesive has a 30 lb./in. peel strength. Such a label was capable of holding the cell in place across a temperature range of −20 to 200 degrees Fahrenheit over an accelerated life test of many years.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example, while the invention has been described as relating to cellular phones and batteries, it will be obvious to those skilled in the art that the invention could be equally used to attach other components as well. Additionally, while pressure sensitive adhesive has been discussed herein, it will be obvious to those skilled in the art that other adhesives, or other materials like VelCro™, would be equally effective.

What is claimed is:

1) A label, comprising:
a. a front face having a first portion and a second portion; and
b. a rear face;
wherein the first portion of the front face is suitable for printing, and the both the second portion of the front face and the rear face have an adhesive disposed thereon.

2) The label of claim 1, further comprising a first overlaminate to cover the second portion of the front face, wherein when the first overlaminate is removed, the adhesive on the second portion of the front face is exposed.

3) The label of claim 2, further comprising a second overlaminate to cover the rear face, wherein when the second overlaminate is removed, the adhesive on the rear face is exposed.

4) The label of claim 3, wherein the adhesive is pressure sensitive adhesive.

5) The label of claim 4, wherein the second overlaminate is manufactured in a form selected from the group consisting of a reel of overlaminate and sheets of overlaminate.

6) The label of claim 5, wherein the first portion comprises text printed thereon.

7) A method of attaching the label of claim 3 to a battery cell comprising the steps of:
a. removing the second overlaminate; and
b. pressing the rear face against the battery cell.

8) A method of attaching a battery cell to a device comprising the steps of:
a. providing the battery cell assembled by the method of claim 7;
b. removing the first overlaminate; and
c. pressing the second portion of the front face against the device.
